(19) United States
(12) Patent Application Publication
(10) Pub. No.: US 2015/0034626 A1
(43) Pub. Date: Feb. 5, 2015

(54) HEATING MEDIUM HEATING APPARATUS AND VEHICLE AIR CONDITIONER PROVIDED WITH SAME

(71) Applicant: MITSUBISHI HEAVY INDUSTRIES AUTOMOTIVE THERMAL SYSTEMS CO., LTD., Kiyosu-shi, Aichi (JP)

(72) Inventors: Satoshi Kominami, Tokyo (JP); Hidetaka Sato, Tokyo (JP)

(73) Assignee: MITSUBISHI HEAVY INDUSTRIES AUTOMOTIVE THERMAL SYSTEMS CO., LTD., Kiyosu-shi, Aichi (JP)

(21) Appl. No.: 14/384,122

(22) PCT Filed: Mar. 26, 2013
(86) PCT No.: PCT/JP2013/058785

§ 371 Date: Sep. 9, 2014

(30) Foreign Application Priority Data
Apr. 16, 2012 (JP) 2012-092965

(51) Int. Cl. B60H 1/22; H05B 1/02

(52) U.S. Cl. CPC B60H 1/2218; H05B 1/0236; B60H 1/2225
USPC 219/483; 219/494; 219/505

(57) ABSTRACT

The disclosure provides a heating medium heating apparatus by which it is possible to directly detect a temperature of a semiconductor switching element such as an IGBT, and to perform high-reliability overheating protection control, while suppressing the number of installations of the temperature sensor, and provides a vehicle air conditioner provided with the heating medium heating apparatus. In the heating medium heating apparatus, at least two PTC heaters are provided, the energization of the PTC heaters is respectively ON/OFF-controlled by a plurality of circuits, each containing a semiconductor switching element (34), and the amount of heating is adjusted. Overheating protection temperature sensors (58 and 59) are respectively installed between two pairs of adjacent semiconductor switching elements (34) of a plurality of the semiconductor switching elements (34). An overheating protection control is performed on each semiconductor switching element (34) based on the detected temperature from each of the temperature sensors (58 and 59), and based on a first threshold value (TH1) when any one of the circuits is turned ON, and a second threshold value (TH2) when both circuits are turned ON.

### TECHNICAL FIELD

The present invention relates to a heating medium heating apparatus that uses a PTC heater so as to heat a heating medium, and a vehicle air conditioner provided with the same.

### BACKGROUND ART

In a vehicle air conditioner applied to electric vehicles, hybrid vehicles, and the like, provided is a heating medium heating apparatus that uses a PTC heater having a positive temperature coefficient (PTC) thermistor element (hereinafter, referred to as a PTC element) as a heat generation element so as to heat a heating medium which is a heat source for heating. In the heating medium heating apparatus, the energization of the PTC heater is controlled via a control circuit having a semiconductor switching element such as an insulated gate bipolar transistor (IGBT) (refer to PTL 1 and PTL 2 for examples).

The IGBT is a power transistor and a heat generating electric component, and it is necessary to manage the junction temperature of the IGBT to be at a limit value or less. The following temperature management methods are known. In one method, an overheating protection control is performed by individually installing a temperature sensor for each of a plurality of the IGBT's, by directly detecting a case temperature of each IGBT, and by limiting a flow of a current to each IGBT. In another method, an overheating protection control is performed by installing a single temperature sensor for the entirety of the IGBT's, by calculating and estimating junction and case temperatures via an arithmetic operation based on the measured value, a predetermined heat model, and an electrical power loss, and by limiting a flow of a current to each IGBT (refer to PTL 3 for example).

### CITATION LIST

### Patent Literature

[PTL 1] Japanese Unexamined Patent Application Publication No. 2011-79344
[PTL 2] Japanese Unexamined Patent Application Publication No. 2012-56351
[PTL 3] Japanese Unexamined Patent Application Publication No. 2008-263774

### SUMMARY OF INVENTION

### Technical Problem

However, in the method in which the number of installations of the temperature sensor is the same as that of the IGBT's, and a temperature of each IGBT is directly detected, the temperature of each IGBT can be accurately detected. However, there is a problem in that the number of temperature sensors increases, thereby increasing the complexity of the structure, and the costs. In contrast, in the method in which junction and case temperatures are estimated via an arithmetic operation based on a detected value of a single temperature sensor, a heat model, an electrical power loss, and the like, there is a problem in that accuracy is inferior to the direct temperature detection method nevertheless a complicated arithmetic operation is required.

The present invention is made in light of these problems, and an object of the present invention is to provide a heating medium heating apparatus by which it is possible to directly detect a temperature of a semiconductor switching element such as an IGBT, and to perform high-reliability overheating protection control, while suppressing the number of installations of the temperature sensor, and to provide a vehicle air conditioner provided with the heating medium heating apparatus.

### Solution to Problem

In a heating medium heating apparatus according to a first aspect of the present invention, at least two PTC heaters are provided, the energization of the PTC heaters is respectively ON/OFF-controlled by a plurality of circuits, each containing a semiconductor switching element, and the amount of heating is adjusted. Overheating protection temperature sensors are respectively installed between two pairs of adjacent semiconductor switching elements of a plurality of the semiconductor switching elements. An overheating protection control is performed on each semiconductor switching element based on the detected temperature from each of the temperature sensors, and based on a first threshold value (TH1) when any one of the circuits is turned ON, and a second threshold value (TH2) when both circuits are turned ON.

According to the first aspect, in the heating medium heating apparatus in which the energization of the plurality of PTC heaters is respectively ON/OFF-controlled by the plurality of circuits, each containing the semiconductor switching element, the overheating protection temperature sensors are respectively installed between the two pairs of adjacent semiconductor switching elements of the plurality of semiconductor switching elements. In addition, an overheating protection control is performed on each semiconductor switching element based on the detected temperature from each of the temperature sensors, and based on the first threshold value (TH1) when any one of the circuits is turned ON, and the second threshold value (TH2) when both circuits are turned ON. For this reason, it is possible to set the number of temperature sensors to half the number of semiconductor switching elements, and to suppress an increase of the number of temperature sensors, while performing an overheating protection control on each semiconductor switching element via direct detection of a temperature of each semiconductor switching element. Accordingly, it is not necessary to estimate and control the temperature of the semiconductor switching element via a complicated arithmetic operation. In addition, it is possible to improve the reliability of the overheating protection control, and to obtain a cost reduction and a simplified configuration by suppressing the number of installations of the temperature sensors.

Furthermore, in the heating medium heating apparatus according to a second aspect of the present invention, when there is a difference in capacity between the two PTC heaters which are respectively controlled by the circuits containing the two semiconductor switching elements, the first threshold value (TH1) is individually set to a threshold value (TH1−A) for one circuit, and a threshold value (TH1−B) for the other circuit.

According to the second aspect, when there is a difference in capacity between the two PTC heaters which are respectively controlled by the circuits containing the two semiconductor switching elements, the first threshold value (TH1) is individually set to the threshold value (TH1−A) for one circuit and the threshold value (TH1−B) for the other circuit. For this reason, when there is a difference in capacity between the two PTC heaters which are respectively controlled by the circuits containing the two semiconductor switching elements, each of which shares the overheating protection temperature sensor, there is also a difference in heating values between the semiconductor switching elements. However, this point being taken into consideration, the first threshold value (TH1) is individually set to the threshold value (TH1−A) or the threshold value (TH1−B), and thus it is possible to individually perform an overheating protection control for each semiconductor switching element to maintain an appropriate temperature. Accordingly, the present invention can be also applied to the plurality of PTC heaters having a difference in capacity therebetween, and it is possible to improve the reliability of an overheating protection control.

In the heating medium heating apparatus according to a third aspect of the present invention, an IGBT is used as the semiconductor switching element in any one of the above-mentioned heating medium heating apparatuses.

According to the third aspect, the IGBT is used as the semiconductor switching element. For this reason, it is also possible to appropriately perform an overheating protection control on a circuit using the IGBT, a junction temperature of which is necessarily managed so as to be at a limit value or less, based on a threshold value which is determined in advance. Accordingly, it is possible to stabilize the circuit for controlling the energization of the PTC heater, and to improve the quality of the heating medium heating apparatus.

In a vehicle air conditioner according to a fourth aspect of the present invention in which a heating medium heated by a heating medium heating apparatus circulates to a radiator provided in an air flow path, any one of the heating medium heating apparatuses described above is used as the heating medium heating apparatus.

According to the fourth aspect, in the vehicle air conditioner in which the heating medium heated by the heating medium heating apparatus circulates to the radiator provided in the air flow path, any one of the heating medium heating apparatuses described above is used as the heating medium heating apparatus. For this reason, it is possible to heat the heating medium using the high-quality high-reliability heating medium heating apparatus, and to supply the heating medium to the radiator provided in the air flow path. Accordingly, it is possible to stabilize the air conditioning performance of the vehicle air conditioner, in particular, the heating performance.

### Advantageous Effects of Invention

In the heating medium heating apparatus of the present invention, it is possible to suppress an increase of the number of temperature sensors by setting the number of temperature sensors to half the number of semiconductor switching elements while performing an overheating protection control on each semiconductor switching element via direct detection of a temperature of each semiconductor switching element. For this reason, it is not necessary to estimate and control the temperature of the semiconductor switching element via a complicated arithmetic operation. In addition, it is possible to improve the reliability of the overheating protection control, and to obtain a cost reduction and a simplified configuration by suppressing the number of installations of the temperature sensors.

In the vehicle air conditioner of the present invention, it is possible to heat the heating medium using the high-quality high-reliability heating medium heating apparatus, and to supply the heating medium to the radiator provided in the air flow path. Accordingly, it is possible to stabilize the air conditioning performance of the vehicle air conditioner, in particular, the heating performance.

### BRIEF DESCRIPTION OF DRAWINGS

FIG. 1 is a schematic configuration view of a vehicle air conditioner provided with a heating medium heating apparatus according to an embodiment of the present invention.

FIG. 2 is an exploded perspective view of the heating medium heating apparatus illustrated in FIG. 1.

FIG. 3 is a vertical cross-sectional view of the heating medium heating apparatus illustrated in FIG. 2, taken along pass-through positions of heating medium inlet and outlet paths.

FIG. 4 is a vertical cross-sectional view of the heating medium heating apparatus illustrated in FIG. 2, taken along positions of connections between a control substrate and harness terminals, and between a control substrate and electrode plate terminals.

FIG. 5 is an exploded perspective view of the heating medium heating apparatus illustrated in FIG. 2 with an upper plate being detached, when seen from above.

FIG. 6 is a plan view of the heating medium heating apparatus illustrated in FIG. 5.

FIG. 7 is a plan view of the heating medium heating apparatus illustrated in FIG. 6 with the control substrate being detached.

FIG. 8 is a cross-sectional view taken along line A-A in FIG. 7.

FIG. 9 is a mapping table illustrating an example of setting threshold values when an overheating protection control is performed based on a detected value of each temperature sensor illustrated in FIG. 8.

### DESCRIPTION OF EMBODIMENTS

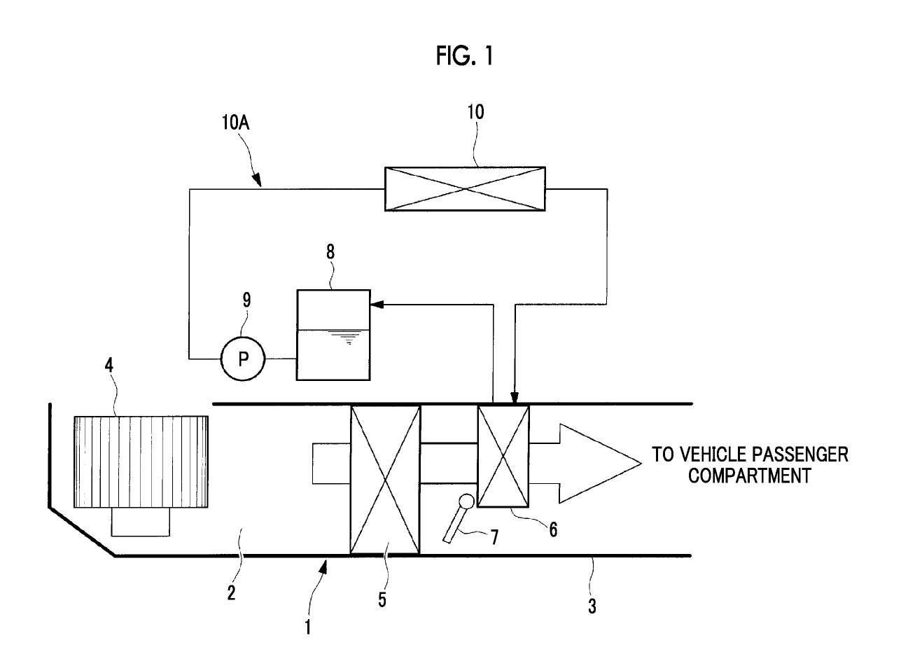

Hereinafter, an embodiment of the present invention will be described with reference to FIGS. 1 to 9.

FIG. 1 is a schematic configuration view of vehicle air conditioner provided with a heating medium heating apparatus according to the embodiment of the present invention.

A casing 3 forming an air flow path 2 is provided in a vehicle air conditioner 1 that takes in outside air or in-vehicle air, controls the temperature of the taken-in air, and introduces the temperature-controlled air into a vehicle passenger compartment.

The following are sequentially installed from upstream to downstream in the air flow path 2 of the casing 3: a blower 4 that takes in outside air or in-vehicle air, boosts the pressure of the taken-in air, and forcibly feeds the pressure boosted air downstream; a cooler 5 that cools the air forcibly fed from the blower 4; a radiator 6 that heats the air passing through the cooler 5 and being cooled thereby; and an air-mixing damper 7 that adjusts a temperature of temperature-conditioned air wind by adjusting a flow rate ratio of the amount of air passing through the radiator 6 to the amount of air bypassing the radiator 6, and by mixing the air downstream of the air-mixing damper 7.

A plurality of blowing ports are connected to a downstream end of the casing 3 so as to blow the temperature-conditioned air into the vehicle passenger compartment via a blow mode switching damper and a duct which are not illustrated.

The cooler 5 is a component of a refrigerant circuit similar to a compressor, a condenser, an expansion valve, and the like which are not illustrated. The cooler 5 cools the air passing therethrough by allowing a refrigerant, adiabatically expanding in the expansion valve, to evaporate. The radiator 6 is a component of a heating medium circulation circuit 10A similar to a tank 8, a pump 9, and a heating medium heating apparatus 10. A heating medium (for example, anti-freezing liquid, hot water, or the like) being heated to a high temperature by the heating medium heating apparatus 10 is allowed to circulate to the radiator 6 by the pump 9, and thus the radiator 6 heats the air passing therethrough.

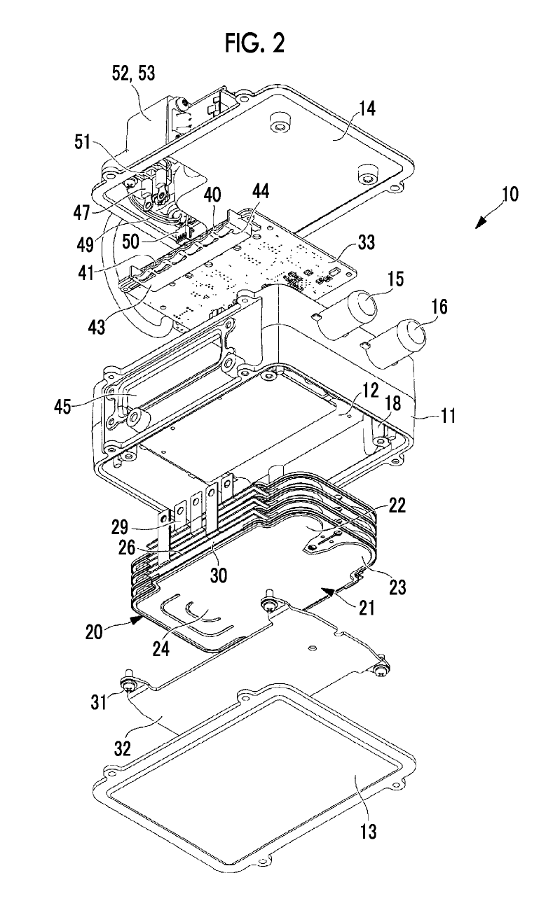

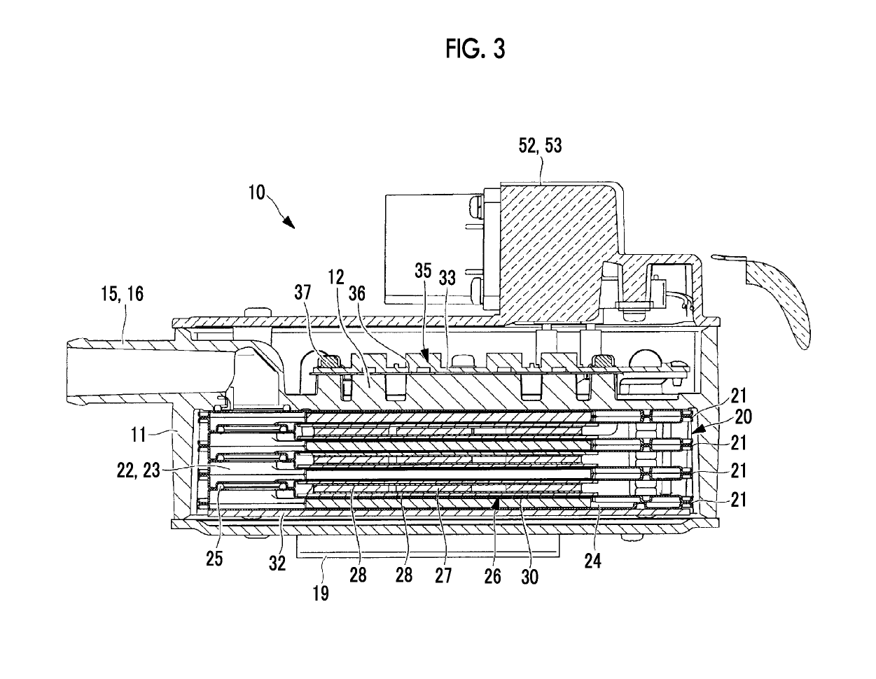

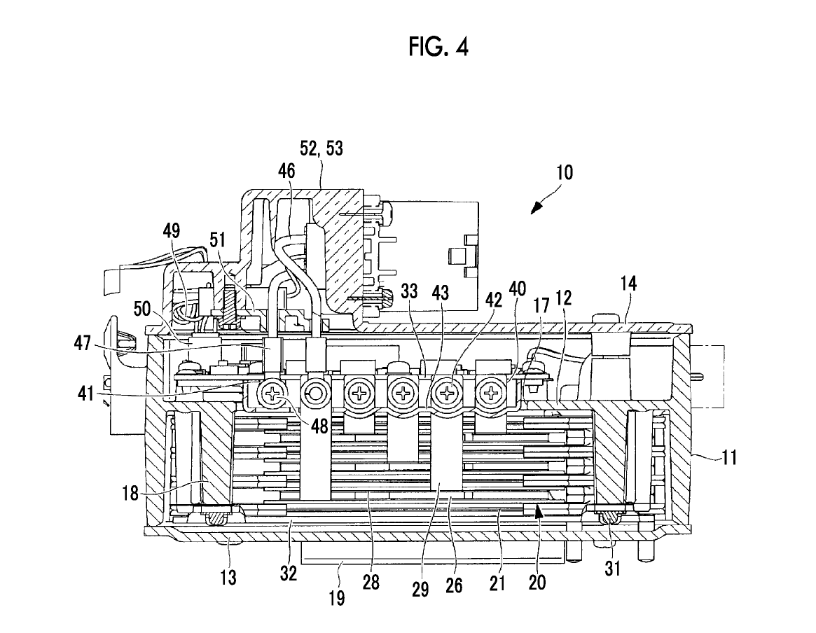

FIG. 2 is an exploded perspective view of the heating medium heating apparatus 10 illustrated in FIG. 1. FIG. 3 is a vertical cross-sectional view, taken along pass-through positions of heating medium inlet and outlet paths of the heating medium heating apparatus 10. FIG. 4 is a vertical cross-sectional view, taken along positions of connections between a control substrate and harness terminals of the heating medium heating apparatus 10, and between a control substrate and electrode plate terminals.

The heating medium heating apparatus 10 includes a rectangular aluminum die casted casing 11, bottom and upper surfaces of which are open, and which includes a partition wall 12 therein. The bottom surface of the casing 11 is sealed with a bottom plate 13 by a screw joint. The upper surface of the casing 11 is sealed with an upper plate 14 by a screw joint.

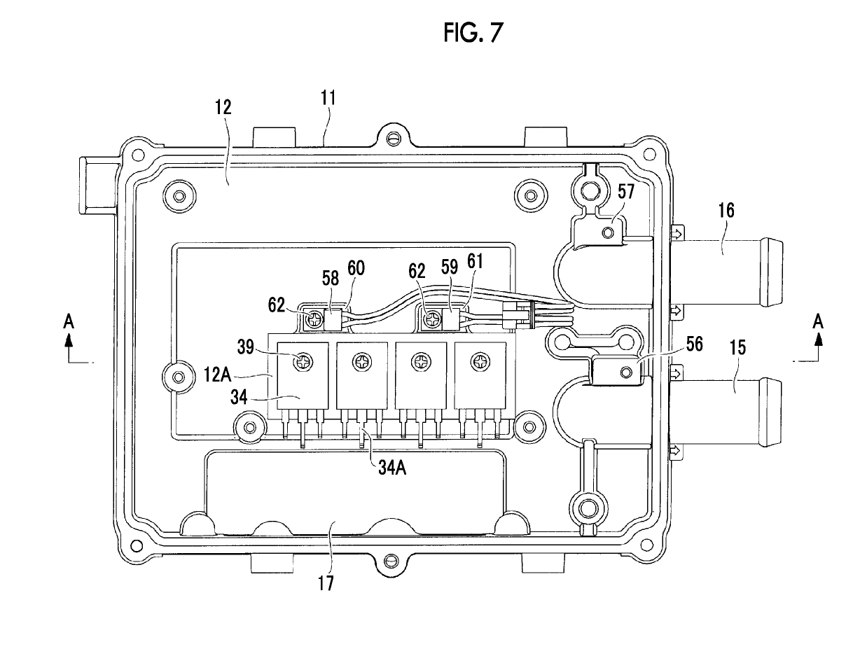

A pair of a heating medium inlet path 15 and a heating medium outlet path 16 is molded integrally in the casing 11. The heating medium inlet path 15 and the heating medium outlet path 16 are provided so as to protrude upwards from an upper surface (one surface) of the partition wall 12, and extend further to the side. The heating medium inlet path 15 and the heating medium outlet path 16 pass through the partition wall 12, and are open on a bottom surface (the other surface) of the partition wall 12. An opening part 17 (refer to FIGS. 4 and 7) is provided along one side of the partition wall 12 so as to allow a plurality of terminals 29 (to be described later) to pass therethrough. Boss parts 18, each having a predetermined height, are integrally molded at four corners on the bottom surface of the partition wall 12. A heat exchanger pressing member 32 (to be described later) is tightened and fixed to the boss parts 18. Brackets 19 for the installation of the heating medium heating apparatus 10 are provided on both of the outer circumferential surfaces of the casing 11.

A heat exchanging element 20 is built-in on a bottom-surface (the other surface) side of the partition wall 12 in the casing 11. The heat exchanging element 20 is obtained by alternatively stacking a plurality (four pieces) of flat heat exchanging tubes 21 and a plurality (four pairs) of PTC heaters 26 in multiple-layers. The plate-shaped heat exchanger pressing member 32 is tightened and fixed to the boss parts 18 by using screws 31, and thus the heat exchanging element 20 is pressed against the partition wall 12, and the flat heat exchanging tubes 21 are brought into close contact with the PTC heaters 26.

The flat heat exchanging tube 21 having a thickness of a few mm is obtained by overlapping a pair of thin press-molded aluminum alloy plates, and by brazing the pair of plates. The flat heat exchanging tube 21 includes an inlet header part 22 and an outlet header part 23 provided at one end thereof, and is provided with a flat tube part 24 having a U-turn flow path that extends from the inlet header part 22, U-turns at the other end of the flat heat exchanging tube 21, and reaches the outlet header part 23. A wave-shaped inner fin (not illustrated) is inserted into the U-turn flow path of the flat tube part 24. Each of the inlet header part 22 and the outlet header part 23 is provided with a communication hole that allows the inlet header part 22 and the outlet header part 23 of the adjacent flat heat exchanging tubes 21 to communicate with each other. The circumference of the communication hole is sealed with a seal member 25 such as an O-ring.

As well known, the PTC heater 26 is configured to have a PTC element 27, and a pair of electrode plates 28 that adhere to opposite surfaces of the PTC element, respectively. The PTC heater 26 has a rectangular plate shape, and the PTC heaters 26 are stacked while being interposed between the flat tube parts 24 of the flat heat exchanging tube 21. The plurality of terminals 29 are provided on the electrode plates 28, being arranged in a straight line separate from each other at predetermined intervals. The terminal 29 extends from one side of the electrode plate 28, and bends upward in an L shape. The plurality of terminals 29 pass through the opening part 17 of the partition wall 12, and extend upward. The PTC heaters 26 are stacked between the flat tube parts 24 via an insulation film, a thermally conductive sheet 30, and the like.

The heat exchanging element 20 is built-in in such a manner that the inlet header part 22 and the outlet header part 23 of the flat heat exchanging tube 21 are communicably connected to the heating medium inlet path 15 and the heating medium outlet path 16, respectively, which are open in the bottom surface (the other surface) of the partition wall 12, passing through the partition wall 12. In addition, the heat exchanging element 20 is built-in in such a manner that the seal members 25 such as an O-ring are respectively installed in a connection part between the inlet header part 22 and the heating medium inlet path 15, and in a connection part between the outlet header part 23 and the heating medium outlet path 16. After the heat exchanging element 20 is built-in, the opening part on the bottom-surface side of the casing 11 is sealed with the bottom plate 13.

As illustrated in FIGS. 3, 5, and 6, a control substrate 33 for controlling the energization of the PTC heater 26 is fixedly installed in a side space (a dead space) of the heating medium inlet path 15 and the heating medium outlet path 16 on an upper-surface side (on one-surface side) of the partition wall 12. A control circuit 35 is mounted on the control substrate 33, and contains a plurality (four in the embodiment) of the semiconductor switching elements 34 for the control of electrical power (hereinafter, simply referred to as the semiconductor switching elements), for example, the IGBT's that control the energization of the plurality (four pairs in the embodiment) of PTC heaters 26. The control substrate 33 is tightened and fixed to the upper surface of the partition wall 12 via a thermally conductive insulation sheet 36 and the like by using screws 37.

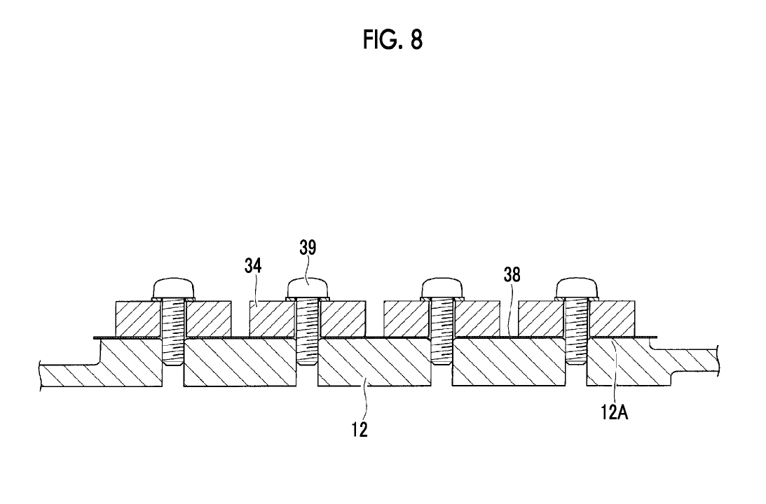

Here, as illustrated in FIGS. 7 and 8, discrete IGBT's are used as the plurality (four pieces) of semiconductor switching elements 34, and are fixedly installed in an upper-surface installation part 12A of the partition wall 12 via thermally conductive insulation sheets 38, for example, silicon sheets by using screws 39. A terminal 34A of the semiconductor switching element 34 is electrically connected to the control circuit 35 mounted on the control substrate 33 via a through-hole of the control substrate 33. The semiconductor switching element 34 is a heat generating electric component, and can be cooled via the partition wall 12 in contact with the flat heat exchanging tube 21 of the heat exchanging element 20, the partition wall 12 functioning as a heat sink. The partition wall 12 is made of aluminum alloy.

Furthermore, the control substrate 33 is provided with a plurality of terminal blocks 40 and two PN terminal blocks 41 adjacent to the terminal blocks 40, which are arranged in series on a lower surface on one side of the control substrate 33. The terminals 29 are screw-connected to the plurality of terminal blocks 40 by using screws 42. The terminals 29 extend from the electrode plates 28 of the PTC heater 26 of the heat exchanging element 20 that is tightened and fixed to the bottom surface (the other surface) of the partition wall 12. PN terminals 47 of a power supply high-voltage harness (an HV harness) 46 (to be described later) are screw-connected to the PN terminal blocks 41 via screws 48, respectively.

The terminals 29 extending from the electrode plates 28 are required to be connected to the terminal blocks 40 of the control substrate 33, while being positioned with respect to the terminal blocks 40. For this reason, a terminal cover 43 is installed on a back surface of the control substrate 33. Since the terminal cover 43 is intended to position the terminals 29, which extend from the electrode plates 28, with respect to the plurality of terminal blocks 40 of the control substrate 33, the terminal cover 43 is fit-installed in the opening part 17 of the partition wall 12 by tightening and fixing the control substrate 33 to the upper surface of the partition wall 12 via screws 37. The terminal cover 43 is integrally molded, and made of a resin material such as PBT having insulation properties. A plurality of positioning holes 44, each having a slit shape, are arranged in a straight line in a portion of the terminal cover 43 fitted into the opening part 17 so as to allow the plurality of terminals 29 to pass therethrough.

That is, the electrode plate 28, that is, the heat exchanging element 20, obtained by stacking the PTC heaters 26 and the flat heat exchanging tubes 21 in multiple-layers, is tightened and fixed to the other surface of the partition wall 12, while the terminal 29 passes through the positioning hole 44 of the terminal cover 43. Accordingly, the PTC heater 26 and the electrode plate 28 can be assembled together without being positionally offset, and the terminal 29 extending from the electrode plate 28 can be positioned with respect to the terminal block 40 of the control substrate 33. The portion of the terminal cover 43, having the positioning holes 44 arranged in series, is molded in a wave shape so as to ensure the strength of the portion.

The control substrate 33 is provided with the plurality of PN terminal blocks 41 to which the PN terminals 47 of the power supply high-voltage harness (the HV harness) 46 diverging in a fork shape are connected via the screws 48. In addition, the control substrate 33 is provided with an LV connector (not illustrated) to which a connector 50 of a control low voltage harness (an LV harness) 49 can be connected. A ring terminal is used as the PN terminal 47 in such a manner that the PN terminal 47 can be connected to the PN terminal block 41 via the screw 48. A top connector is used as the connector 50 in such a manner that the connector 50 can be inserted from above, and connected to the LV connector.

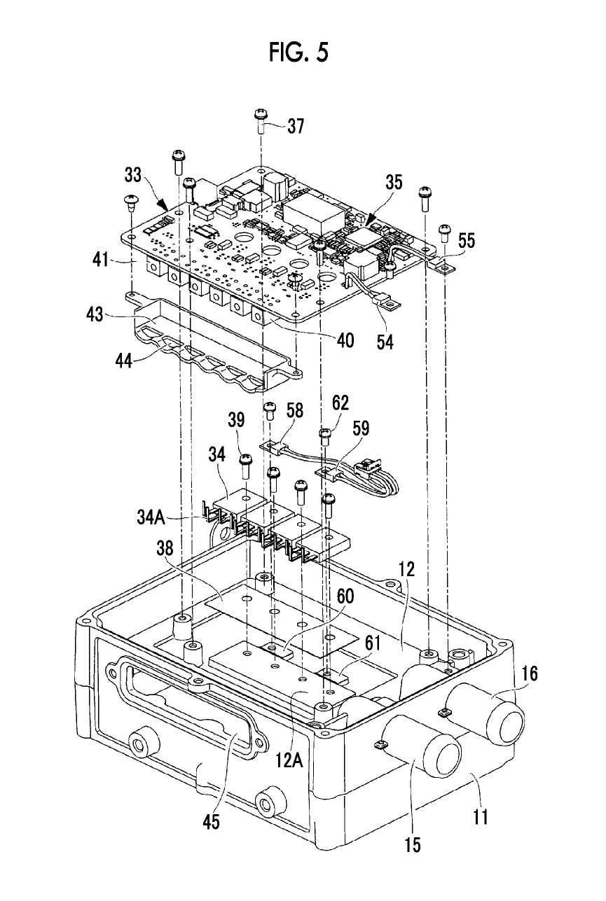

In contrast, as illustrated in FIGS. 2 and 5, a window 45 for a screw connection operation is open in one side surface of the casing 11 so as to help the screw connections when the terminal 29 of the electrode plate 28 is screw-connected to the terminal block 40 via the screw 42, and when the PN terminal (the ring terminal) 47 of the power supply HV harness 46 is screw-connected to the PN terminal block 41 via the screw 48. The window 45 for a screw connection operation has such a size that the screws 42 and 48 can be tightened via the window 45 for a screw connection operation. The window 45 for a screw connection operation can be blocked with an attachable and detachable cover which is not illustrated.

After the control substrate 33 is installed, and the terminal 29 integrated with the electrode plate 28 is screw-connected to the terminal block 40 of the control substrate 33, the opening part on the upper-surface side of the casing 11 can be sealed with the upper plate 14. The upper plate 14 is mounted in such a manner that the casing 11 is sealed via a sealing material such as liquid gasket. When the upper plate 14 is mounted on the casing 11, the PN terminal 47 of the HV harness 46 provided on the upper plate 14 is allowed to extend to a predetermined position by a harness holder 51 so that the PN terminal 47 can be connected to the PN terminal block 41 of the control substrate 33, and the connector 50 of the control LV harness 49 is set so as to be connected to the LV connector of the control substrate 33.

Connection parts 52 and 53 for the power supply HV harness 46 and the control LV harness 49 are provided in a space on an upper surface of the upper plate 14, the space being positioned opposite to the extension direction of the heating medium inlet path 15 and the heating medium outlet path 16. The connection parts 52 and 53 can be connected to a battery and an upper-level control unit (an ECU) via cables and harnesses which are not illustrated. From the perspective of workability when the heating medium heating apparatus 10 is mounted in a vehicle, the harness connection parts 52 and 53 are installed in such a manner that the power supply HV harness from the battery, and the control LV harness from the upper-level control unit can be connected to the harness connection parts 52 and 53 from a front surface of the casing 11 of the heating medium heating apparatus 10 mounted in the vehicle.

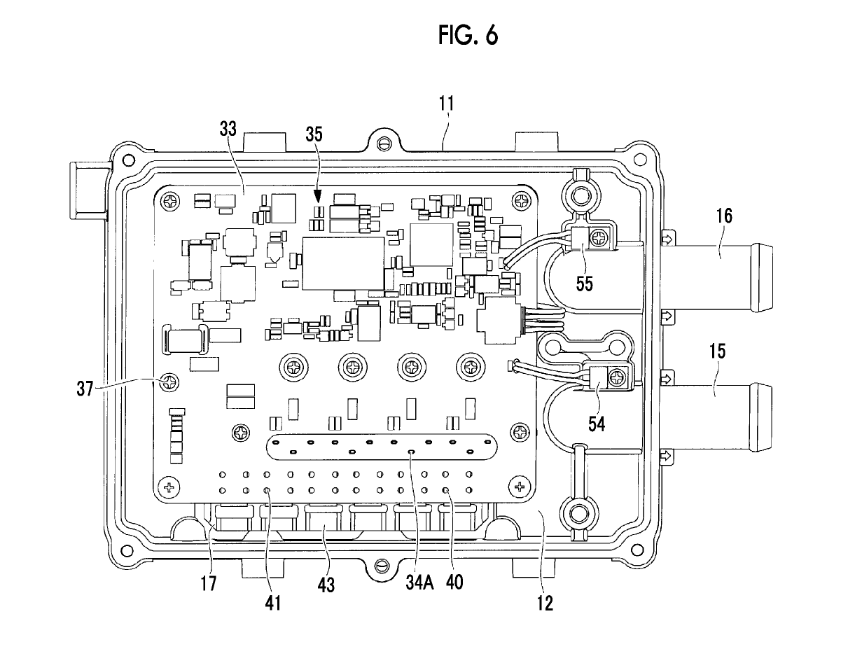

Furthermore, in the embodiment, as illustrated in FIG. 7, an installation part 56 for a temperature sensor 54 for the detection of a heating medium inlet temperature is provided in a raised portion of the heating medium inlet path 15 rising from the partition wall 12. In addition, an installation part 57 for a temperature sensor 55 for the detection of a heating medium outlet temperature is provided in a raised portion of the heating medium outlet path 16 rising from the partition wall 12. The heating medium inlet temperature sensor 54 and the heating medium outlet temperature sensor 55 (refer to FIG. 6) are respectively installed on the installation parts 56 and 57 by using screw connections. The detected values from the temperature sensors 54 and 55 are input to the control substrate 33, and are used for temperature control. Two overheating protection temperature sensors 58 and 59 are installed on installation parts 60 and 61 close to the installation part 12A of the semiconductor switching element 34 via a screw connection using a screw 62, so as to prevent the overheating of the four semiconductor switching elements 34 which are heat generating electric components, and to protect the semiconductor switching elements 34.

A total of two overheating protection temperature sensors 58 and 59 are respectively installed at middle positions between two pairs of adjacent semiconductor switching elements 34 of the four semiconductor switching elements 34 arranged in line. The overheating protection temperature sensors 58 and 59 can directly detect the temperatures of two pairs of adjacent semiconductor switching elements 34, respectively. The detected values are input to an overheating protection control circuit of the control substrate 33, and when the detected temperatures exceed threshold values which are determined in advance, an overheating protection control such as a current limit is performed.

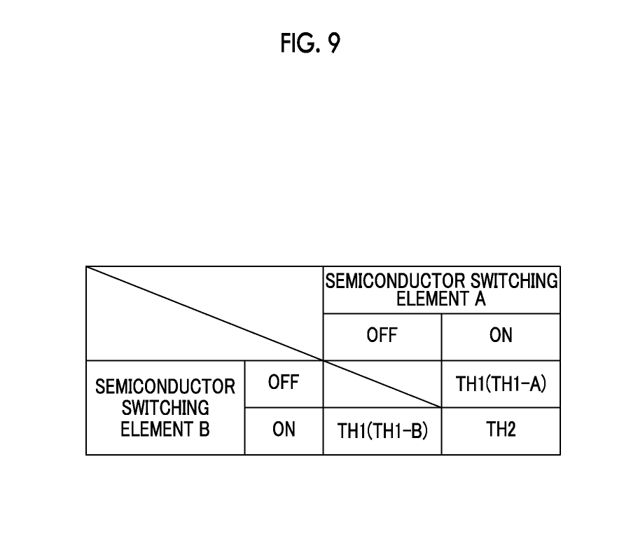

As illustrated in FIG. 9, two pairs of adjacent semiconductor switching elements 34, the temperatures of which are detected by the two overheating protection temperature sensors 58 and 59, are respectively defined as semiconductor switching elements A and B. When any one of the semiconductor switching elements A and B is turned ON, the threshold value for the overheating protection control is set to be a first threshold value TH1. When both the semiconductor switching elements A and B are turned ON, the threshold value for the overheating protection control is set to be a second threshold value TH2. When there is a difference in capacity between two PTC heaters 26 which are respectively controlled by the circuits containing the two semiconductor switching elements A and B, it is preferred that the first threshold value TH1 be individually set to a threshold value TH1−A for one circuit, and a threshold value TH1−B for the other circuit.

However, with regard to the above-mentioned threshold values, when the “first threshold value TH1 is less than the second threshold value TH2”, and the first threshold value TH1 is individually set for the two circuits, the threshold value for the PTC heater 26 with a greater capacity is set to be a high value to the extent that one of the PTC heaters 26 has a capacity greater than the other.

The heating medium flows into the heating medium heating apparatus 10 via the heating medium inlet path 15 of the casing 11. Thereafter, in each of the pluralities of flat heat exchanging tubes 21 of the heat exchanging element 20, while the heating medium flows into the flat tube part 24 via the inlet header part 22, and flows through the U-turn flow path of the flat tube part 24, the heating medium is heated by the PTC heater 26, the temperature of the heating medium increases, and the heating medium flows to the outlet header part 23. Thereafter, the heating medium flows from the outlet header part 23 to the outside via the heating medium outlet path 16. The heating medium flowing out of the heating medium heating apparatus 10 is supplied to the radiator 6 via the heating medium circulation circuit 10A (refer to FIG. 1), and is used for heating.

In contrast, electrical power is applied to the PTC heater 26 via the control substrate 33 from the power supply HV harness 46 connected to the harness connection part 52 of the upper plate 14. A control signal is input to the control substrate 33 via the control LV harness 49 connected to the harness connection part 53. The amount of heating is controlled by controlling the electrical power applied to each of the plural pairs of PTC heaters 26 via the semiconductor switching element 34, the control circuit 35, and the like based on the heating medium outlet and inlet temperatures from the temperature sensors 54 and 55, the set temperatures, and the like.

At this time, heat generated by the semiconductor switching element 34 is thermally conducted to the partition wall 12 of the aluminum die casted casing 11. The semiconductor switching element 34 is cooled by the partition wall 12 functioning as a heat sink, and by the heating medium flowing through the flat heat exchanging tube 21 functioning as a cooling heat source. That is, the heat generated by the semiconductor switching element 34 which is a heat generating electric component, radiates to the partition wall 12 via the thermally conductive insulation sheet 38. The semiconductor switching element 34 can be cooled by the heating medium flowing as the cooling heat source through the flat heat exchanging tube 21 of the heat exchanging element 20, and being cooled to a specified value or less.

However, since the semiconductor switching element 34 may be overheated due to an overload, a temperature of the semiconductor switching element 34 is detected, and the semiconductor switching element 34 is prevented from being overheated. In the embodiment, one of each of the overheating protection temperature sensors 58 and 59 are installed at each middle position between two pairs (A and B) of adjacent semiconductor switching elements 34 of the plurality (four) of semiconductor switching elements 34. In addition, the heating medium heating apparatus 10 is configured to perform an overheating protection control on the two semiconductor switching elements 34 (A and B) based on the detected temperatures from the temperature sensors 58 and 59, and based on the first threshold value (TH1) when the control circuit of the PTC heater 26 containing any one of the two semiconductor switching elements (A and B) is turned ON, and the second threshold value (TH2) when both control circuits are turned ON.

For this reason, it is possible to set the number of temperature sensors (58 and 59) to half the number of semiconductor switching elements 34, and to suppress an increase in the number of temperature sensors (58 and 59), while performing an overheating protection control on each semiconductor switching element 34 via direct detection of a temperature of each semiconductor switching element 34. Accordingly, it is not necessary to estimate and control the temperature of the semiconductor switching element 34 via a complicated arithmetic operation. In addition, it is possible to improve the reliability of the overheating protection control, and to obtain a cost reduction and a simplified configuration by suppressing the number of installations of the temperature sensors (58 and 59).

When there is a difference in capacity between the two PTC heaters 26 which are respectively controlled by the circuits containing the two semiconductor switching elements 34 (A and B), the first threshold value (TH1) is individually set to the threshold value (TH1−A) for one circuit, and the threshold value (TH1−B) for the other circuit. For this reason, when there is a difference in capacity between the two PTC heaters 26 which are respectively controlled by the circuits containing the two semiconductor switching elements 34 (A and B), each of which shares the overheating protection temperature sensor 58 or 59, there is also a difference in heating values between the semiconductor switching elements 34. However, this point being taken into consideration, the first threshold value (TH1) is individually set to the threshold value (TH1−A) or the threshold value (TH1−B), and thus it is possible to individually perform an overheating protection control for each semiconductor switching element 34 to maintain an appropriate temperature. Accordingly, similarly, the present invention can be also applied to the plurality of PTC heaters 26 having a difference in capacity therebetween, and it is possible to improve the reliability of an overheating protection control.

Furthermore, in the embodiment, since the IGBT is used as the semiconductor switching element 34, it is also possible to appropriately perform an overheating protection control on a circuit using the IGBT, a junction temperature of which is necessarily managed so as to be at a limit value or less, based on a threshold value which is determined in advance. Accordingly, it is possible to stabilize the circuit for controlling the energization of the PTC heater 26, and to improve the quality of the heating medium heating apparatus 10.

In the vehicle air conditioner 1 according to the embodiment, it is possible to heat the heating medium using the high-quality high-reliability heating medium heating apparatus 10, and to supply the heating medium to the radiator 6 provided in the air flow path 2. Accordingly, it is possible to stabilize the air conditioning performance of the vehicle air conditioner 1, in particular, the heating performance.

The present invention is not limited to the embodiment, and modifications can be appropriately made insofar as the modifications do not depart from the scopes of the present invention. For example, the above-mentioned embodiment has the configuration in which the plurality of flat heat exchanging tubes 21 are stacked in multiple-layers, and the plurality of PTC heaters 26 are built-in between the flat heat exchanging tubes 21. However, the number of flat heat exchanging tubes 21 and the number of PTC heaters 26 are appropriately increased and reduced so as to correspond to the capacity of the heating medium heating apparatus 10.

In the embodiment, the flat heat exchanging tube 21 is used in which the inlet header part 22 and the outlet header part 23 are provided in line at one end of the flat heat exchanging tube 21, and the U-turn flow path is formed between the inlet header part 22 and the outlet header part 23. The inlet header part may be provided at one end of the flat heat exchanging tube 21, and the outlet header part may be provided at the other end thereof. At this time, the heating medium inlet path 15 and the heating medium outlet path 16 which are provided in the casing 11 are also provided on right and left portions of the casing 11, respectively, so as to correspond to the positions of the inlet header part and the outlet header part.

In the embodiment, the aluminum die casted casing 11 is used, but the casing 11 may be made of a resin material such as PPS. At this time, it is preferred that at least a portion functioning as a heat sink in the partition wall 12 be made of an aluminum alloy plate material or the like. In the embodiment, the discrete IGBT is used as the semiconductor switching element 34. However, the type of semiconductor switching element 34 is not limited to the IGBT, and may adopt a surface mounting type.

### REFERENCE SIGNS LIST

1: vehicle air conditioner
2: air flow path
6: radiator
10: heating medium heating apparatus
10A: heating medium circulation circuit
26: PTC heater
34: semiconductor switching element (IGBT)
35: control circuit
58, 59: overheating protection temperature sensor

1. A heating medium heating apparatus in which at least two PTC heaters are provided, the energization of the PTC heaters is respectively ON/OFF-controlled by a plurality of circuits, each containing a semiconductor switching element, and the amount of heating is adjusted,
wherein overheating protection temperature sensors are respectively installed between two pairs of adjacent semiconductor switching elements of a plurality of the semiconductor switching elements, and
wherein an overheating protection control is performed on each semiconductor switching element based on the detected temperature from each of the temperature sensors, and based on a first threshold value (TH1) when any one of the circuits is turned ON, and a second threshold value (TH2) when both circuits are turned ON.

2. The heating medium heating apparatus according to claim 1,
wherein when there is a difference in capacity between the two PTC heaters which are respectively controlled by the circuits containing the two semiconductor switching elements, the first threshold value (TH1) is individually set to a threshold value (TH1−A) for one circuit, and a threshold value (TH1−B) for the other circuit.

3. The heating medium heating apparatus according to claim 1,
wherein an IGBT is used as the semiconductor switching element.

4. A vehicle air conditioner in which a heating medium heated by a heating medium heating apparatus circulates to a radiator provided in an air flow path,
wherein the heating medium heating apparatus described in claim 1 is used as the heating medium heating apparatus.

5. The heating medium heating apparatus according to claim 2,
wherein an IGBT is used as the semiconductor switching element.

6. A vehicle air conditioner in which a heating medium heated by a heating medium heating apparatus circulates to a radiator provided in an air flow path,
wherein the heating medium heating apparatus described in claim 2 is used as the heating medium heating apparatus.

7. A vehicle air conditioner in which a heating medium heated by a heating medium heating apparatus circulates to a radiator provided in an air flow path,
wherein the heating medium heating apparatus described in claim 3 is used as the heating medium heating apparatus.
